(19) United States
(12) Patent Application Publication
(10) Pub. No.: US 2018/0020467 A1
(43) Pub. Date: Jan. 18, 2018

(54) SCHEDULING VOICE-OVER-IP USERS IN WIRELESS SYSTEMS USING CARRIER AGGREGATION

(71) Applicants: Ahmed NOUAH, Ottawa (CA); Alireza MIRZAEE, Ottawa (ON)

(72) Inventors: Ahmed NOUAH, Ottawa (CA); Alireza MIRZAEE, Ottawa (ON)

(73) Assignee: TELEFONAKTIEBOLAGET LM ERICSSON (PUBL), Stockholm (SE)

(21) Appl. No.: 15/546,591

(22) PCT Filed: Feb. 3, 2015
(86) PCT No.: PCT/IB2015/050822

§ 371 Date: Jul. 26, 2017

(51) Int. Cl. H04W 72/12; H04L 5/14; H04L 5/00; H04W 72/04; H04L 1/18

(52) U.S. Cl. CPC H04W 72/1247; H04L 5/14; H04L 5/001; H04L 5/0032; H04L 1/1887; H04W 72/0446; H04W 72/1215

(57) ABSTRACT

Scheduling of delay-sensitive downlink traffic in a downlink carrier aggregation scenario is performed in such a way as to take advantage of the unambiguous HARQ feedback that is available when the downlink assignment is transmitted coincident with an uplink TDD subframe on the secondary carrier. An example method, in a wireless network node supporting downlink carrier aggregation of a primary carrier in Frequency Division Duplexing, FDD, mode and a secondary carrier in Time-Division Duplexing, TDD, mode, includes determining (710) that a first user device supported or to be supported with said downlink carrier aggregation has Bela sensitive downlink traffic. Subsequent scheduling of the first user device's delay-sensitive downlink traffic is prioritized (720) in transmission-time intervals, TTIs, in which the subframe of the secondary carrier is an uplink subframe. The delay-sensitive downlink traffic may be voice-over-Internet-Protocol, VoIP, traffic, for example.

### TECHNICAL FIELD

The technology disclosed herein relates generally to wireless telecommunications networks, and more particularly relates to techniques for supporting downlink carrier aggregation and delay-sensitive downlink traffic in such networks.

### BACKGROUND

Carrier Aggregation Carrier aggregation is one of the features recently developed by the members of the 3rd-Generation Partnership Project (3GPP) for so-called Long Term Evolution (LTE) systems, formally referred to as the Enhanced Universal Terrestrial Radio Access Network (E-UTRAN), and is standardized as part of LTE Release 10, which is also known as LTE-Advanced.

An earlier version of the LTE standards, LTE Release 8, supports transmission bandwidths up to 20 MHz. However, the very high data rates contemplated for LTE-Advanced will require an expansion of the transmission bandwidth. Accordingly, bandwidths up to 100 MHz are supported in LTE-Advanced, through the use of carrier aggregation. To maintain backward compatibility with LTE Release 8 mobile terminals, the available spectrum is divided into Release 8—compatible chunks called component carriers. Carrier aggregation enables bandwidth expansion beyond the limits of LTE Release 8 systems by allowing mobile terminals to transmit and receive data over multiple component carriers, which together can cover up to 100 MHz of spectrum. Importantly, the carrier aggregation approach ensures compatibility with earlier Release 8 mobile terminals, while also ensuring efficient use of a wide carrier by making it possible for legacy mobile terminals to be scheduled in all parts of the wideband LTE-Advanced carrier.

The number of aggregated component carriers, as well as the bandwidth of the individual component carrier, may be different for uplink (UL) and downlink (DL) transmissions. A carrier configuration is referred to as “symmetric” when the number of component carriers in each of the downlink and the uplink are the same. In an asymmetric configuration, on the other hand, the number of component carriers differs between the downlink and uplink Further, the number of component carriers configured for a geographic cell area may be different from the number of component carriers seen by a given mobile terminal. A mobile terminal, for example, may support more downlink component carriers than uplink component carriers, even though the same number of uplink and downlink component carriers may be offered by the network in a particular area.

LTE carriers can be operated in either Frequency-Division Duplex (FDD) mode or Time-Division Duplex (TDD) mode. In FDD mode, downlink and uplink transmissions take place in different, sufficiently separated, frequency bands. In TDD mode, on the other hand, downlink and uplink transmission take place in different, non-overlapping time slots. Thus, TDD can operate in unpaired spectrum, whereas FDD requires paired spectrum. TDD mode also allows for different asymmetries in terms of the amount of resources allocated for uplink and downlink transmission, respectively, by means of different uplink/downlink configurations. These differing uplink/downlink configurations permit the shared frequency resources to be allocated to downlink and uplink use in differing proportions. Accordingly, uplink and downlink resources can be allocated asymmetrically for a given TDD carrier.

### HARQ Feedback

Automatic Repeat Request (ARQ) is an error-control technique used in many wireless networks. With ARQ, a receiver of data transmissions sends acknowledgements (ACKs) or negative acknowledgments (NACKs) to inform the transmitter of whether each message has been correctly received. Incorrectly received messages, as well as messages that are not acknowledged at all, can then be re-transmitted.

Hybrid ARQ (HARQ) combines ARQ with the use of forward error-correction (FEC) coding of the data messages, to improve the ability of the receiver to receive and correctly decode the transmitted messages. As with conventional ARQ, receivers employing HARQ send ACKs and NACKs, as appropriate, after each attempt to decode a message. These ACKs and NACKs are referred to as “HARQ feedback.”

For downlink transmissions in LTE systems, HARQ feedback is sent from the UE (user equipment—3GPP terminology for a mobile terminal) to the network on either the Physical Uplink Control Channel (PUCCH) or the Physical Uplink Shared Channel (PUSCH), depending on whether or not the UE has separately been scheduled for uplink PUSCH transmission.

For each downlink transmission to the UE, the UE will transmit an ACK or NACK, depending on whether or not the transmission was correctly received. The network can, apart from detecting ACK or NACK, also draw the conclusion that the UE did not hear the corresponding downlink assignment, if it detects no feedback from the UE when anticipated. The UE state when the UE does not detect a downlink assignment (and thus does not send an ACK or NACK for a corresponding data message) is referred to as DTX. (DTX stands for “discontinuous transmission”; here it indicates that no transmission was detected by the UE. In reality, of course, one might have been sent.) On the network side, the DTX state means that the network has not received an ACK or NACK for a given transmission to the UE; in the case of DTX, the network will re-transmit the data, marked as a new transmission. Note, however, that a missed ACK/NACK detection on the network side could of course also be due to that the network fails to receive it properly even though it was transmitted by the UE.

Of course, a NACK received by the network will trigger a retransmission, whereas the reception of an ACK allows the corresponding HARQ transmit (Tx) process to be flushed and re-used. That a HARQ Tx process has been flushed and is being re-used is indicated to the UE from the network side by toggling the NDI (New Data Indicator) flag in the next downlink assignment (for this HARQ process), along with the new data. This, in turn, will cause the UE to flush the corresponding HARQ receive (Rx) process and associate the newly received data with the current HARQ Rx process.

DTX detection at the network, as described above, is an indication of a probable failure by the UE to correctly decode the Physical Downlink Control Channel (PDCCH) or enhanced PDCCH (ePDCCH), and may thus be used for the purpose of PDCCH/ePDCCH link adaptation—i.e., adapting the robustness of the physical control channel that carries the DL grant.

### HARQ Feedback in Downlink Carrier Aggregation

One consideration for carrier aggregation is how to transmit control signaling from the mobile terminal on the uplink to the wireless network. Uplink control signaling may include ACK and NACK signaling according to HARQ protocols, as discussed above, as well as channel state information (CSI) and channel quality information (CQI) reporting for downlink scheduling. Uplink control signaling also includes scheduling requests (SRs) indicating that the mobile terminal needs uplink resources for uplink data transmissions.

In LTE systems that use carrier aggregation, a single uplink carrier is used by a mobile terminal to carry ACK/NACK and channel-state information for several downlink carriers. Further, in LTE systems that use TDD, ACK/NACK information for several downlink subframes may need to be transmitted in a single uplink subframe. In systems that use both TDD and carrier aggregation, then, a relatively large number of ACK/NACK bits and CSI bits may need to be transmitted in a single uplink subframe, on a single uplink carrier.

In downlink FDD carrier aggregation, link adaptation suffers from HARQ ambiguities when one or more secondary cells are used. The downlink HARQ feedback is sent on the primary cell PUCCH if no uplink grant is assigned to the UE and it is sent on the primary cell PUSCH otherwise. In case of two carriers, the PUCCH Format 1B with channel selection is used. The UE has to send HARQ feedback for both configured carriers. The HARQ feedbacks from both carriers are mapped to a QPSK symbol that will be sent on one of the configured PUCCH channels. This mapping is done according to the 3GPP tables described in Tables 10.1.2.2.1-3/4/5 of the 3GPP document 3GPP TS 36.213, v. 12.4.0 (January 2015), available at www.3gpp.org. As an example, the mapping table for two configured codewords per carrier, when only a single downlink secondary carrier is used, is shown in FIG. 1.

The right-most column in the table shown in FIG. 1 lists the bit values for the transmitted QPSK symbol, while the column next to that shows which of the four PUCCH channels the symbol is transmitted on. The remaining columns indicate the ACK, NACK, or DTX conditions signaled for each of the up to four codewords transmitted in the downlink

The table reproduced in FIG. 1 shows that in many cases, there is no way for the base station (an “eNodeB” or “eNB,” in LTE terminology) that receives the HARQ feedback to determine whether the UE did not receive the corresponding downlink assignment (DTX) or whether the downlink assignment was received but the UE was unable to decode the corresponding downlink data (NACK). This is a problem that arises when both carriers are used to carry downlink data to the UE—if only the primary cell is in use, the UE will be able to distinguish the NACK from DTX without any ambiguity.

In the case of more than two configured component carriers, if only the primary cell is in use, PUCCH Format 1A/1B will be used to carry the HARQ feedback. If at least one secondary cell is used, the UE has to send the HARQ feedback for each of the configured secondary carriers using PUCCH Format 3. Since the UE has to send NACK or NACK-NACK for the unused carriers, the ambiguity between DTX and NACK still exists, for many cases.

When the HARQ is sent on PUSCH, the UE has to concatenate the HARQ bits from all configured carriers. If a carrier is not used, a NACK or NACK-NACK is sent for that carrier. As a result, the DTX/NACK ambiguity still exists.

Further details of carrier aggregation, TDD operation, and HARQ feedback in LTE are provided in U.S. patent application Ser. No. 13/814,953, filed 8 Feb. 2013, the entire contents of which are incorporated herein as background for the inventive techniques and apparatus described below.

### SUMMARY

In the case of joint FDD and TDD carrier aggregation when the primary cell is operated in FDD mode, PUCCH Format 1B plus channel selection is used to transmit HARQ feedback when the downlink assignment is transmitted in a subframe (of the primary carrier) corresponding to when the TDD secondary cell subframe is a downlink or special subframe. In this case, NACK/DTX ambiguities like those shown in FIG. 1 arise. When the downlink assignment is transmitted in a subframe when the corresponding secondary cell is an uplink TDD subframe, on the other hand, PUCCH format 1A/1B is used. In this case, the traffic scheduled at the corresponding primary cell subframes does not suffer from DTX/NACK ambiguities. In the case of FDD and TDD carrier aggregation with FDD as primary cell and more than one TDD as secondary cell, PUCCH Format 3 is used to transmit the HARQ feedback. Ambiguities as to whether NACK or DTX is being signaled by the UE exist in many feedback scenarios, when any of the secondary cells is in use.

NACK/DTX ambiguities create difficulties in performing link adaptation of the Physical Downlink Control Channel (PDCCH). This in turn can create performance problems, particularly with respect to delay-sensitive downlink traffic, such as voice-over-Internet Protocol (VoIP) traffic. In addition, because of the NACK/DTX ambiguities, the corresponding data has to be re-transmitted, but marked as a new transmission, since the eNB doesn't know whether the UE attempted (and failed) to decode the first transmission. This means that the UE will not be able to perform packet combining (as it does in the case of retransmissions), which reduces the chance of a correct data decoding after the retransmission.

Embodiments of the presently disclosed invention perform scheduling of delay-sensitive downlink traffic in such a way as to take advantage of the unambiguous HARQ feedback that is available when the downlink assignment is transmitted coincident with an uplink TDD subframe on the secondary carrier.

In some embodiments, users that have both VOIP and other traffic, which may generally require usage of the secondary cell, will be frequently scheduled at transmission-time intervals (TTIs) where the secondary cell subframe is an uplink subframe. For these TTIs, the HARQ feedback will not suffer from any carrier aggregation HARQ DTX/NACK ambiguity—as a result, the link adaptation process will be provided with reliable HARQ feedback on a frequent basis, allowing better usage of the resources while preserving the VOIP quality. In some embodiments, the delay-sensitive traffic in particular is scheduled in these particular TTIs, to allow the UE to use packet combining techniques in case of retransmission. This increases the probability of decoding the delay-sensitivity traffic correctly and helps reduce the latency.

Example embodiments of the inventive techniques and apparatus detailed below include a method, in a wireless network node supporting downlink carrier aggregation of a primary carrier in Frequency-Division Duplexing (FDD) mode and a secondary carrier in Time-Division Duplexing (TDD) mode. This example method includes determining that a first user device supported or to be supported with said downlink carrier aggregation has delay-sensitive downlink traffic. The delay-sensitive downlink traffic may be voice-over-Internet-Protocol (VoIP) traffic, for example. The method further comprises prioritizing subsequent scheduling of the first user device's delay-sensitive downlink traffic in transmission-time intervals (TTIs) in which the subframe of the secondary carrier is an uplink subframe, based on this determination. In some embodiments, this prioritizing is further based on determining that the first user device has additional downlink traffic that requires usage of the secondary cell.

In some embodiments of this method, prioritizing subsequent scheduling of the first user device's delay-sensitive downlink traffic in TTIs in which the subframe of the secondary carrier is an uplink subframe comprises scheduling all or substantially all of the first user device's delay-sensitive downlink traffic in said TTIs. In some embodiments or in some instances of this method, the downlink carrier aggregation comprises only a single secondary carrier, and prioritizing subsequent scheduling of the first user device's delay-sensitive downlink traffic in TTIs in which the subframe of the secondary carrier is an uplink subframe comprises, for each TTI in which the subframe of the secondary carrier is an uplink subframe, scheduling available delay-sensitive downlink traffic for the first user device and/or delay-sensitive downlink traffic for any other user device in the TTI, before scheduling any non-delay sensitive downlink traffic in the TTI.

In some embodiments, the method further comprises scheduling at least some non-delay-sensitive downlink traffic for the first user device in TTIs in which the subframe of the secondary carrier is not an uplink subframe. In some of these embodiments, the method further comprises monitoring hybrid automatic-repeat-request (HARQ) feedback and scheduling a sufficient portion of the non-delay-sensitive downlink traffic in TTIs in which the subframe of the secondary carrier is an uplink subframe to ensure that at least a predetermined proportion of unambiguous HARQ feedback is received for the first user device.

Other embodiments of the presently disclosed techniques and apparatus include a network node supporting downlink carrier aggregation of a primary carrier in FDD mode and a secondary carrier in TDD mode and having embodiments corresponding to the methods summarized above. The network node comprises, in some embodiments, a radio transceiver circuit configured to communicate with one or more user devices and a processing circuit configured to control the radio transceiver circuit. The processing circuit is further configured to determine that a first user device supported or to be supported with said downlink carrier aggregation has delay-sensitive downlink traffic, and to prioritize subsequent scheduling of the first user device's delay-sensitive downlink traffic in TTIs in which the subframe of the secondary carrier is an uplink subframe. Once again, the delay-sensitive downlink traffic may be VoIP traffic, for example. Further, the prioritization may be further based on a determination that first user device has additional downlink traffic that requires usage of the secondary cell.

In some embodiments of this example network node, the processing circuit is configured to prioritize subsequent scheduling of the first user device's delay-sensitive downlink traffic in TTIs in which the subframe of the secondary carrier is an uplink subframe by scheduling all or substantially all of the first user device's delay-sensitive downlink traffic in said TTIs. In some embodiments, the downlink carrier aggregation comprises only a single secondary carrier and the processing circuit is configured to prioritize subsequent scheduling of the first user device's delay-sensitive downlink traffic in TTIs in which the subframe of the secondary carrier is an uplink subframe by, for each TTI in which the subframe of the secondary carrier is an uplink subframe, scheduling available delay-sensitive downlink traffic for the first user device and/or delay-sensitive downlink traffic for any other user device in the TTI, before scheduling any non-delay sensitive downlink traffic in the TTI.

In some embodiments, the processing circuit is further configured to schedule at least some non-delay-sensitive downlink traffic for the first user device in TTIs in which the subframe of the secondary carrier is not an uplink subframe. In some of these embodiments, the processing circuit is still further configured to monitor hybrid automatic-repeat-request (HARQ) feedback and schedule a sufficient portion of the non-delay-sensitive downlink traffic in TTIs in which the subframe of the secondary carrier is an uplink subframe to ensure that at least a predetermined proportion of unambiguous HARQ feedback is received for the first user device.

Other embodiments of the inventive techniques and apparatus disclosed herein include a non-transitory computer-readable medium comprising, stored thereupon, a computer program product comprising program instructions that, when executed by a processor in a wireless network node supporting downlink carrier aggregation of a primary carrier in FDD mode and a secondary carrier in TDD mode, cause the wireless network node to carry out one or more of the methods summarized above.

Examples of these and other methods and apparatus are described in detail below.

### BRIEF DESCRIPTION OF THE DRAWINGS

FIG. 1 illustrates details of the HARQ feedback for an example downlink carrier aggregation configuration.

FIG. 2 illustrates components of an LTE network.

FIG. 3 illustrates HARQ feedback signaling for an example downlink carrier aggregation configuration.

FIG. 4 illustrates the preferred transmission-time intervals (TTIs) in an example downlink carrier aggregation configuration.

FIG. 5 is a process flow diagram illustrating an example method as carried out in a network node.

FIG. 6 illustrates the Time-Division Duplexing (TDD) uplink/downlink configurations.

FIG. 7 is a process flow diagram illustrating an example method as carried out in a network node.

FIG. 8 is a block diagram illustrating components of an example network node.

FIG. 9 provides another view of an example network node.

### DETAILED DESCRIPTION

Inventive concepts will now be described more fully hereinafter with reference to the accompanying drawings, in which examples of embodiments of inventive concepts are shown. These inventive concepts may, however, be embodied in many different forms and should not be construed as limited to the embodiments set forth herein. Rather, these embodiments are provided so that this disclosure will be thorough and complete, and fully convey the scope of present inventive concepts to those skilled in the art. It should also be noted that these embodiments are not mutually exclusive. Components from one embodiment may be tacitly assumed to be present or used in another embodiment.

For purposes of illustration and explanation only, these and other embodiments of present inventive concepts are described herein in the context of operating in a Radio Access Network (RAN) that communicates over radio communication channels with mobile terminals (also referred to as terminal devices, wireless terminals or UEs). As used herein, a mobile terminal, terminal device, wireless terminal, or UE can include any device that receives data from a communication network, and may include, but is not limited to, a mobile telephone (“cellular” telephone), laptop/portable computer, pocket computer, hand-held computer, desktop computer, a machine to machine (M2M) or Machine-Type Communication (MTC) type device, a sensor with a wireless communication interface, etc.

In some embodiments of a RAN, several base stations may be connected (e.g., by landlines or radio channels) to a radio network controller (RNC). A radio network controller, also sometimes termed a base station controller (BSC), may supervise and coordinate various activities of the plural base stations connected thereto. A radio network controller may be connected to one or more core networks. According to some other embodiments of a RAN, base stations may be connected to one or more core networks without a separate RNC(s) between, for example, with functionality of an RNC implemented at base stations and/or core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) technology. UTRAN, short for UMTS Terrestrial Radio Access Network, is a collective term for the Node B's and Radio Network Controllers that make up the UMTS radio access network. Thus, UTRAN is essentially a radio access network using wideband code division multiple access (WCDMA) for terminal devices.

The Third Generation Partnership Project (3GPP) has undertaken to further evolve the UTRAN and GSM based radio access network technologies. In this regard, specifications for the Evolved Universal Terrestrial Radio Access Network (E-UTRAN) have been developed by the 3GPP. The Evolved Universal Terrestrial Radio Access Network (E-UTRAN) comprises the Long Term Evolution (LTE) and System Architecture Evolution (SAE), and detailed embodiments of the presently disclosed techniques and apparatus are described in the specific context of the LTE system.

However, while terminology and examples from LTE are used in this disclosure to exemplify embodiments of the inventive concepts, this should not be seen as limiting the scope of inventive concepts to only these systems. Other wireless systems, including variations and successors of 3GPP LTE and WCDMA systems, WiMAX (Worldwide Interoperability for Microwave Access), UMB (Ultra Mobile Broadband), HSDPA (High-Speed Downlink Packet Access), GSM (Global System for Mobile Communications), etc., may also benefit from exploiting embodiments of present inventive concepts disclosed herein.

The Evolved UMTS Terrestrial Radio Access Network (E-UTRAN) includes base stations called enhanced NodeBs (eNBs or eNodeBs), providing the E-UTRA user plane and control plane protocol terminations towards the terminal device. The eNBs are interconnected with each other using the X2 interface. The eNBs are also connected using the S1 interface to the EPC (Evolved Packet Core), more specifically to the MME (Mobility Management Entity) by means of the S1-MME interface and to the Serving Gateway (S-GW) by means of the S1-U interface. The S1 interface supports many-to-many relation between MMEs/S-GWs and eNBs. A simplified view of the E-UTRAN architecture is illustrated in FIG. 2.

The eNB 210 hosts functionalities such as Radio Resource Management (RRM), radio bearer control, admission control, header compression of user plane data towards serving gateway, and/or routing of user plane data towards the serving gateway. The MME 220 is the control node that processes the signaling between the terminal device and the CN (core network). Significant functions of the MME 220 are related to connection management and bearer management, which are handled via Non Access Stratum (NAS) protocols. The S-GW 230 is the anchor point for terminal device mobility, and also includes other functionalities such as temporary DL (down link) data buffering while the terminal device is being paged, packet routing and forwarding to the right eNB, and/or gathering of information for charging and lawful interception. The Packet Data Network (PDN) Gateway (P-GW, not shown in FIG. 2) is the node responsible for terminal device IP address allocation, as well as Quality of Service (QoS) enforcement (as further discussed below). The reader is referred to 3GPP TS 36.300 and the references therein for further details of functionalities of the different nodes.

In describing various embodiments of the presently disclosed techniques, the non-limiting term radio network node may be used to refer any type of network node serving terminal device and/or connected to other network node or network element or any radio node from where terminal device receives signal. Examples of radio network nodes are Node B's, base stations (BS), multi-standard radio (MSR) radio nodes such as MSR BS's, eNodeB's, network controllers, radio network controllers (RNCs), base station controllers, relays, donor nodes controlling relays, base transceiver stations (BTS), access points (AP), wireless routers, transmission points, transmission nodes, remote radio units (RRUs), remote radio heads (RRHs), nodes in a distributed antenna system (DAS), etc.

In some cases a more general term “network node” is used; this term may correspond to any type of radio network node or any network node that communicates with at least a radio network node. Examples of network nodes are any radio network node stated above, core network nodes (e.g., Mobile Switching Center, Mobility Management Entity, etc.), Operations & Maintenance, Operations & Support System, and positioning nodes, Minimization of Drive Test nodes, etc.

In describing some embodiments, the term terminal device is used, and refers to any type of wireless device communicating with a radio network node in a cellular or mobile communication system. Examples of terminal devices are user equipment(UE), target devices, device-to-device terminal devices, machine-type terminal devices or terminal devices capable of machine-to-machine communication, PDAs, wireless-enabled table computers, mobile terminals, smart phones, laptop embedded equipped (LEE), laptop mounted equipment (LME), USB dongles, customer premises equipment (CPE), etc. The term “mobile terminal” as used herein should be understood as being generally interchangeable with the terms UE and terminal device as used herein and in the various specifications promulgated by the 3GPP, but should not be understood as being limited to devices compliant to 3GPP standards.

LTE networks are expected to carry an increasing volume of voice-over-Internet Protocol (VoIP) traffic. VoIP traffic is delay-sensitive. To guarantee good voice quality, the one-way, end-to-end, delay should be less than 250 milliseconds. Generally, a VOIP user is considered satisfied if 98% of its packets are received successfully with no more than a 50-millisecond air interface delay, during the whole voice call. A system's VOIP capacity is the number of users per cell when 95% of the users are satisfied.

Having an efficient link adaptation for both the downlink control channel, PDCCH, and the downlink data channel, PDSCH, is critical to satisfying the VOIP requirements. In general, the efficiency of the link adaptation is proportional to the frequency of updates, which, as explained in further detail below, can be limited by the availability of reliable HARQ feedback.

Joint FDD and TDD carrier aggregation was introduced in Release 12 of the LTE standards. Since this introduction was relatively recent, no particularized solution exists to handle VOIP traffic in this carrier aggregation scenario. Instead, it has so far been assumed that the same techniques adopted for FDD-only carrier aggregation will continue to apply.

In the case of joint FDD and TDD carrier aggregation when the primary cell is operated in FDD mode, PUCCH Format 1B plus channel selection is used to transmit HARQ feedback when the downlink assignment is transmitted in a subframe (of the primary carrier) corresponding to when the TDD secondary cell subframe is a downlink or special subframe. In this case, NACK/DTX ambiguities like those shown in FIG. 1 arise. When the downlink assignment is transmitted in a subframe when the corresponding secondary cell is an uplink TDD subframe, on the other hand, PUCCH format 1A/1B is used. In this case, the traffic scheduled at the corresponding primary cell subframes does not suffer from DTX/NACK ambiguities. In case of FDD and TDD carrier aggregation with FDD as primary cell and more than one TDD as secondary cell, PUCCH Format 3 is used to transmit the HARQ feedback. Ambiguities as to whether NACK or DTX is being signaled by the UE exist in many of these cases, when any of the secondary cells is in use.

NACK/DTX ambiguities create difficulties in performing link adaptation of the Physical Downlink Control Channel (PDCCH). This in turn can create performance problems, particularly with respect to delay-sensitive downlink traffic, such as voice-over-Internet Protocol (VoIP) traffic.

More particularly, the presence of DTX/NACK ambiguities in the HARQ feedback in a carrier aggregation context can cause several problems that affect an LTE system's capacity for handling VoIP. These problems arise in PDCCH link adaptation, PDSCH link adaptation, and downlink scheduling.

First, an LTE system's capacity for handling VoIP with dynamic scheduling is dependent on the available PDCCH resources. The PDCCH link adaptation is very critical to optimizing the PDCCH resources. The PDCCH link adaptation process responds to the receipt of DTX feedback by decreasing its estimation of the link's Signal-to-Interference-plus-Noise Ratio (SINR) estimation. The PDCCH link adaptation process responds to the receipt of either ACK or NACK feedback to increase its estimation of the link's SINR, since the receipt of either ACK or NACK implies that the UE successfully received and decoded the downlink assignment on PDCCH, even if it subsequently failed to successfully decode the transmitted data on the PDSCH.

The presence of DTX/NACK ambiguities, as discussed above in the background section, makes the PDCCH link adaptation inefficient. In the case of FDD-only carrier aggregation, two approaches are commonly used to overcome these ambiguities. The first solution consists of freezing the link adaptation process's outer loop updates until an unambiguous feedback is received. The second approach is to incorporate the ambiguous HARQ feedback into loop updates, but by applying different increments than with unambiguous feedbacks. Both of these approaches, however, can compromise the efficiency of the link adaptation, leading to resource usage increases per user. Consequently, in a heavily loaded system, some users cannot be scheduled and others cannot be scheduled on time, resulting in increased packet delivery delays.

PDSCH link adaption is also adversely affected by DTX/NACK ambiguities in the HARQ feedback. The PDSCH link adaptation process responds to the receipt of NACK feedback by decreasing its SINR estimate for the PDSCH, and responds to the receipt of ACK by increasing it. In the case of ambiguity between NACK and DTX, the PDSCH link adaptation process typically considers the feedback as NACK and decreases the estimated SINR. This leads to a more conservative assignment of modulation and coding scheme (MCS) to the link, which can impact the overall capacity.

For the downlink scheduler, the ambiguities are considered as DTXs rather than NACKs. As a result, the faulty packets are retransmitted as new transmissions. Consequently, no packet combining is performed at UE level. Successful VOIP packet decoding, in bad channel conditions, is compromised, which results in increased delays to decode packets.

The above limitations impact the VOIP capacity and the VOIP satisfaction for an LTE network. An adaptation of the processes for handling VoIP in the context of FDD-TDD carrier aggregation is thus required.

One possible solution is to simply restrict a UE using VoIP from using the secondary cell entirely, so that the HARQ feedback will never be ambiguous. Another possible solution is to restrict the UE from using the secondary cell more than occasionally, so as to increase the link adaptation performance. In both cases, however, VOIP users with other types of traffic that require usage of the secondary cell are negatively impacted.

Another solution, detailed herein, arises from the fact that an FDD-TDD carrier aggregation, where the primary carrier is operating in FDD mode, offers the possibility to arrange scheduling to avoid some of the ambiguities.

More particularly, embodiments of the presently disclosed techniques and apparatus perform scheduling of delay-sensitive downlink traffic in such a way as to take advantage of the unambiguous HARQ feedback that is available when the downlink assignment is transmitted coincident with an uplink TDD subframe on the secondary carrier.

In some embodiments, users that have both VOIP and other traffic, which may generally require usage of the secondary cell, will be frequently scheduled at transmission-time intervals (TTIs) where the secondary cell subframe is an uplink subframe. For these TTIs, the HARQ feedback will not suffer from any carrier aggregation HARQ DTX/NACK ambiguity—as a result, the link adaptation process will be provided with reliable HARQ feedback on a frequent basis, allowing better usage of the resources while preserving the VOIP quality. In some embodiments, the delay-sensitive traffic in particular is scheduled in these particular TTIs, to allow the UE to use packet combining techniques in case of retransmission. This increases the probability of decoding the delay-sensitivity traffic correctly and helps reduce the latency.

Users with delay-sensitive traffic only, or having both delay-sensitive traffic and additional traffic that does not require a secondary carrier, will be using the primary cell only. It is preferable that these users are not scheduled on the TTIs where the secondary subframes are uplink subframes, thus reserving these “preferred” subframes for users that have delay-sensitive traffic and require the use of the secondary cell. This is particularly true when the number of VOIP users with traffic requiring usage of one or more secondary cells is high.

### HARQ Feedback in FDD-TDD Carrier Aggregation

According to the LTE specifications, in joint FDD-TDD carrier aggregation, with the FDD carrier as primary cell, the UE shall, upon detection of any Physical Downlink Shared Channel (PDSCH) transmission on any serving cell at subframe n, transmit the corresponding HARQ-ACK feedback in subframe n+4.

If the UE is assigned an uplink grant for that subframe, the HARQ feedback is sent on the Physical Uplink Shared Channel (PUSCH). Otherwise, the HARQ feedback is sent on the Physical Uplink Control Channel (PUCCH).

According to the standards, a UE configured to use two serving cells, with the primary cell as FDD and the secondary as TDD, must use the following formats when transmitting its HARQ feedback on the primary cell PUCCH:
Case 1: Format 1B with carrier selection to transmit the HARQ feedback at subframe n+4 for the transmitted PDSCH at subframe n when the corresponding TDD subframe is a downlink subframe or a special subframe. (As is well known to those familiar with the LTE specifications, a “special” subframe in LTE TDD is a subframe that has a downlink portion, an uplink portion, and an intervening guard portion.)
Case 2: Format 1A/1B to transmit the HARQ feedback at subframe n+4 for a transmitted PDSCH at subframe n when the corresponding TDD subframe is an uplink subframe.

In case 1, the UE uses the FDD channel selection tables (Tables 10.1.2.2.1-1,x in 3GPP TS 36.213) to map the HARQ feedbacks from the primary cell and secondary cell to a QPSK signal (b₀b₁) and an index to the PUCCH channel that should be used.

The table reproduced in FIG. 1 is one of these tables, and is the table that applies when the number of configured code words is two for both serving cells. HARQ-ACK(0) and HARQ-ACK(1) are the HARQ feedback related to the primary cell for the first and second code word respectively. HARQ-ACK(2) and HARQ-ACK(3) are related to the secondary cell.

It can be easily seen that in all cases where the HARQ-ACK for both code words is NACK/DTX, the receiver will not be able to distinguish the DTX from the NACK. This ambiguity has an impact on the link adaptation and on the retransmissions.

In case 2, the UE uses Format1A/1B, depending on the number of scheduled code words. The HARQ bits are concatenated and mapped to a QPSK symbol that is transmitted on the first PUCCH channel. Importantly, the detection can be done without ambiguity in this case.

FIG. 3 illustrates the HARQ feedback scenarios described above for one of the several possible TDD uplink/downlink configurations of the secondary cell. (In this particular example, TDD uplink/downlink configuration 2 is used for the secondary cell.) If a downlink packet is transmitted to the UE in the first (left-most) subframe, this is coincident with a downlink subframe in the secondary cell. Accordingly, the resulting HARQ feedback is transmitted four subframes later, using Format 1B, with channel selection (CS). If a downlink packet is transmitted to the UE in the second subframe, this is coincident with a special subframe in the secondary cell. Once again, the resulting HARQ feedback is transmitted four subframes later, using Format 1B with channel selection.

On the other hand, if the downlink packet is transmitted to the UE in the third subframe, this is coincident with an uplink subframe in the secondary cell. In this case, the HARQ feedback is transmitted, four subframes later, using Format 1A/1B. As explained above, this format has no DTX/NACK ambiguities.

If more than one secondary carrier is configured, then Format 3 is used if any of the secondary cells is scheduled. The UE uses Format 1A/1B if only the primary carrier is scheduled. For multi-cell scheduling instances, when Format 3 is used, the UE has to set the HARQ feedback to NACK for any unscheduled cells. Accordingly, the eNB cannot distinguish DTX from NACK, creating additional DTX/NACK ambiguities.

In the case of FDD+TDD carrier aggregation with FDD primary cell and TDD secondary cell, when HARQ transmission is in a subframe for which the UE has an uplink assignment, the HARQ feedback is transmitted on PUSCH. In this case, the UE should:
Case 1: concatenate the HARQ feedbacks related to any PDSCH transmissions at subframe n for both serving cells, apply the appropriate coding and transmit the feedback at subframe n+4. This applies only when the corresponding TDD subframe is a downlink subframe or a special subframe. If no PDSCH transmission is detected on one serving cell, its related HARQ is set to NACK or NAC-NACK depending on the configured number of code words. This can lead to detection of ambiguity between NACK and DTX.
Case 2: if, at subframe n, the TDD subframe is an uplink subframe and a PDSCH transmission is detected on the primary cell, the HARQ feedback has to be properly coded and then sent at subframe n+4.

As seen above, there a number of situations in which the HARQ feedback can be unambiguous, in a FDD-TDD carrier aggregation scenario. However, there are certain situations in which the HARQ feedback is unambiguous. In particular, the HARQ feedback is unambiguous when the downlink transmission to the UE is scheduled, on the primary carrier, in a subframe coinciding with an uplink subframe on the secondary carrier.

These subframes can be referred to as “preferred subframes” or “preferred TTIs” for the purpose of this disclosure. These preferred subframes can be used strategically, to ensure that the link adaptation processes have reliable HARQ feedback for delay-sensitive traffic, to minimize the latencies in such traffic.

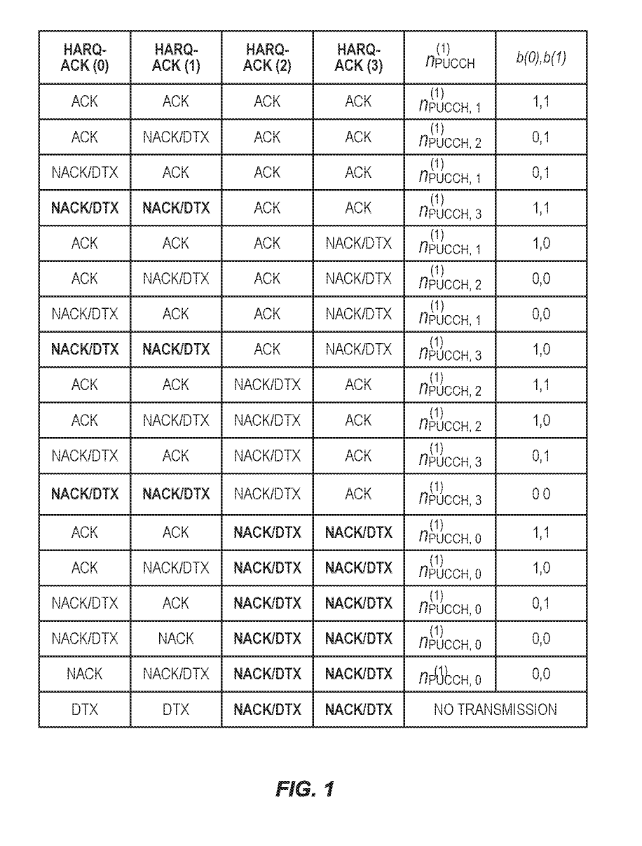

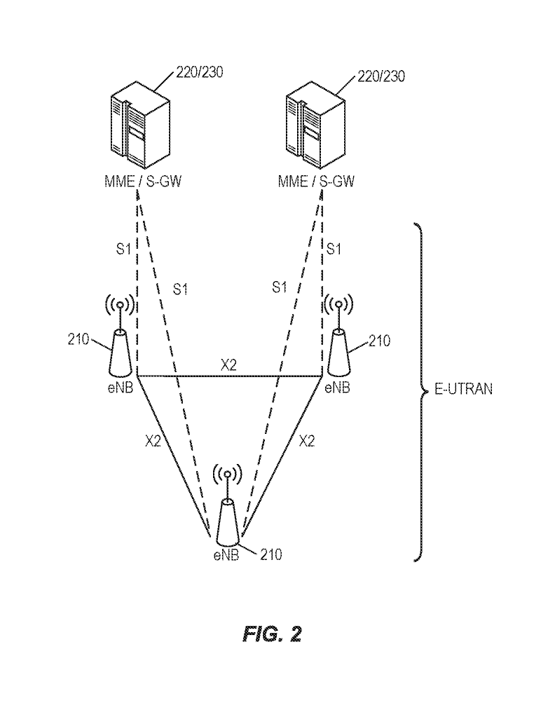

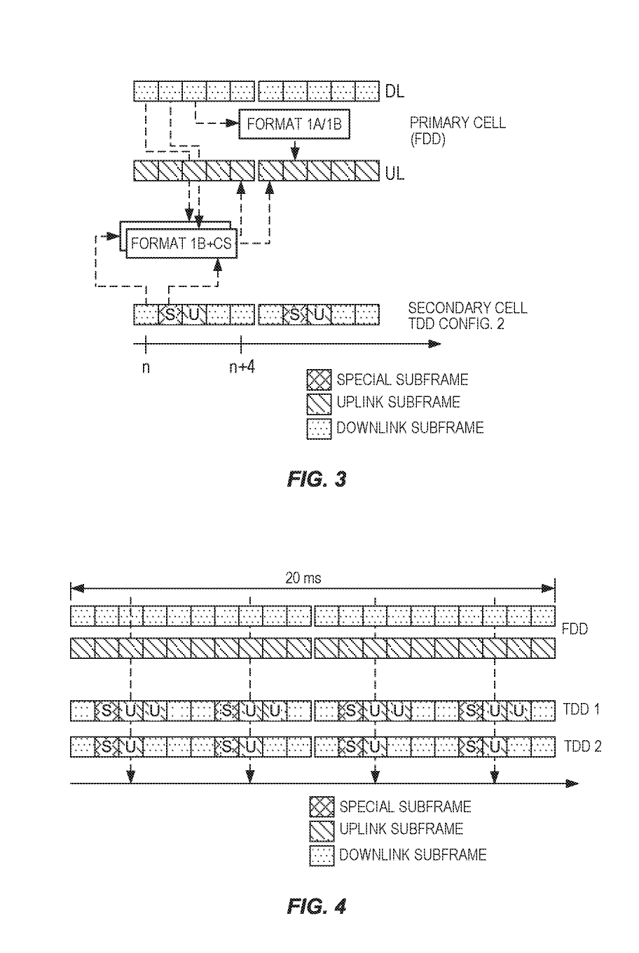

For a given TTI, if all of the subframes for the secondary carriers are uplink subframes, then this TTI is a “preferred TTI.” It should be appreciated that the locations of these preferred TTIs will vary, depending on the TDD uplink/downlink configuration for each secondary carrier, and depending on the particular combination of TDD uplink/downlink configurations, in the event that there is more than one secondary carrier. FIG. 4 illustrates one example of FDD-TDD carrier aggregation with two secondary carriers. The first (top) TDD carrier in the illustration has TDD uplink/downlink configuration 1, while the second (bottom) TDD carrier has uplink/downlink configuration 2. As seen in the figure, these have a simultaneous uplink subframe only every fifth subframe. These are “preferred TTIs,” for the purpose of the presently disclosed techniques.

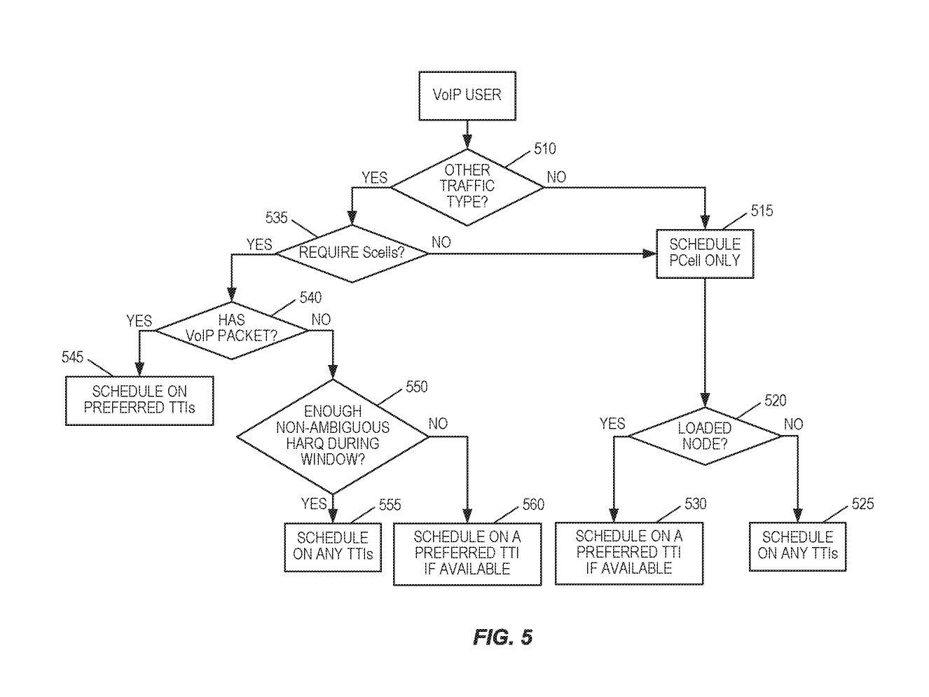

FIG. 5 is a process flow diagram illustrating an example embodiment of a solution for exploiting these preferred TTIs to improve the handling of delay-sensitive traffic, such as VoIP traffic, in an LTE network.

As shown at blocks 510 and 515, if a given VoIP user has no other traffic type, it is simply scheduled on the primary cell, or “PCell.” In this case, the base station determines whether it is a “loaded node,” in that it serves a large number of VoIP users with other types of traffic that require usage of one or more secondary cells, as shown at block 520. If it is not, it makes little difference where the traffic for the VoIP user is scheduled, so it can be scheduled in any TTI, as shown at block 525. (Note that because the user in this case is scheduled only on the primary carrier, the HARQ feedback for this user is always unambiguous.) On the other hand, if the base station is a loaded node, then the user's traffic is preferentially scheduled on non-preferred TTIs, as shown at block 530. This frees up the preferred TTIs for VoIP users that have additional traffic that requires the use of a secondary carrier, and that will benefit from the use of these preferred TTIs.

These VoIP users take the other main branch of the illustrated process. As shown at blocks 535 and 515, a VoIP user that has other traffic but that does not require the use of a secondary carrier, or “SCell,” can be scheduled on the primary carrier only. If the VoIP user has other traffic that requires the use of a secondary carrier, on the other hand, then the process continues at block 540. As shown at block 540, the eNB determines whether the user has a VoIP packet to be scheduled. If so, the VoIP packet is scheduled on a preferred TTI, as shown at block 545. If not, the eNB checks whether there has been enough unambiguous HARQ feedback for that user in a preceding “ambiguity monitoring window” to provide sufficient link adaptation, i.e., to provide a sufficient proportion of unambiguous HARQ feedback to provide the link adaptation loop with a reliable measure of the channel conditions. This is shown at block 550. If so, then the non-VoIP packet can be scheduled on any TTI, as shown at block 555. If not, the non-VoIP packet is scheduled on a preferred TTI, if available, as shown at block 560, so that the link adaption loop can obtain some additional unambiguous HARQ feedback.

According to the illustrated process, for the users using VOIP-only traffic or some other traffic not requiring the usage of a secondary cell, only the primary cell will be scheduled. For these users, there will be no ambiguity in HARQ feedback and these users can be scheduled on any subframe. This applies to both one TDD secondary cell and multiple TDD secondary cells. At a loaded VOIP user node, however, it is recommended to avoid scheduling these UEs at preferred TTIs.

The UEs receiving VOIP data plus another type of traffic that require the usage of the secondary cell are given priority to be scheduled at preferred TTIs. User data that contains a VOIP packet is scheduled on a preferred TTI. The other data will be scheduled at different TTIs and the HARQ feedback is monitored over an ambiguity monitoring window that encompasses a predefined number of TTIs. If the number of ambiguous HARQ feedback in that monitoring window exceeds some threshold, the data will be scheduled at preferred TTIs, if available, to ensure that the link adaptation is updated with unambiguous HARQ feedback sufficiently often.

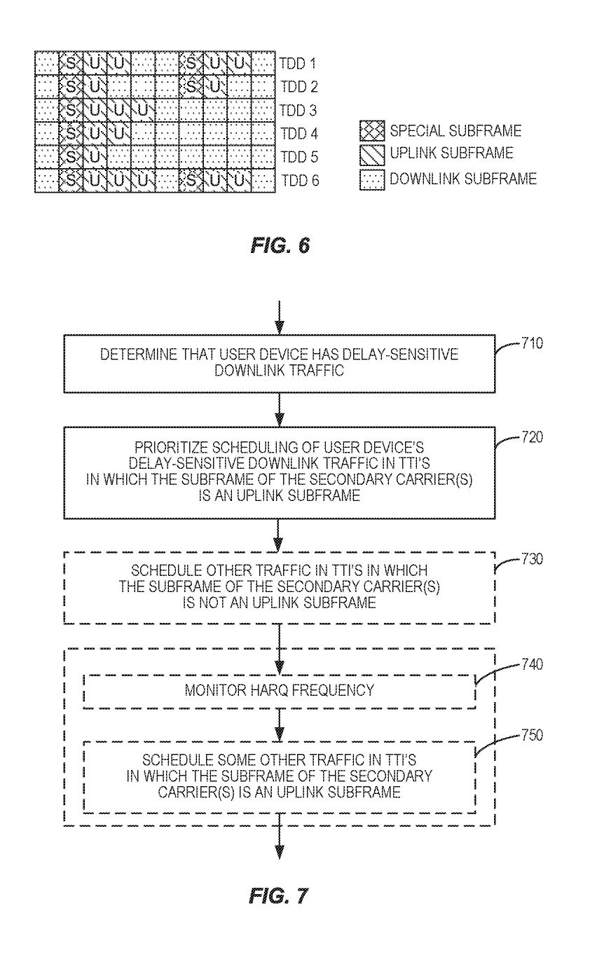

The number of preferred TTIs available for scheduling according to the above-described techniques depends on the TDD uplink/downlink configuration. This can be seen in FIG. 6, which illustrates all of the TDD uplink/downlink configurations except for TDD uplink/downlink configuration 0. (TDD uplink/downlink configuration 0 is not considered here, since it is an uplink oriented configuration that is not suitable for downlink carrier aggregation.) Per radio frame, the number of preferred TTIs is:
1 TTI for TDD uplink/downlink configuration 5;
2 TTIs for TDD uplink/downlink configurations 2 and 4;
3 TTIs for TDD uplink/downlink configuration 3;
4 TTIs for TDD uplink/downlink configuration 1; and
5 TTIs for TDD uplink/downlink configuration 6.

The minimum time interval between scheduling opportunities on preferred TTIs also varies according to the TDD uplink/downlink configuration, as can be seen in FIG. 6. Since each subframe is 1 millisecond and the uplink/downlink configuration repeats for each radio frame of 10 milliseconds, the minimum time interval between non-consecutive scheduling opportunities is:
4 milliseconds for configuration 1;
5 milliseconds for configuration 2;
8 milliseconds for configuration 3;
9 milliseconds for configuration 4;
10 milliseconds for configuration 5; and
3 milliseconds for configuration 6.

When planning and/or configuring networks that support VoIP or other delay-sensitive downlink traffic, network operators should consider the number of preferred TTIs provided by a given carrier aggregation configuration, as well as the minimum time interval between scheduling opportunities on these preferred TTIs, when selecting the carrier configurations for downlink carrier aggregation. Configuration 6 has the best minimum time interval, but may not be very suitable for downlink aggregation because of the the high ratio of uplink subframes to downlink subframes. TDD uplink/downlink configurations 1 and 2 present a good trade-off between dowlink capacity and the opportunities for efficient link adaptation updates.

In case of multiple TDD secondary cells, the combination of TDD uplink/downlink configuration defines the number of preferred TTIs. Any combination of TDD configurations allows at least one opportunity of unambiguous feedback per radio frame.

In view of the detailed examples presented above, it will be appreciated that FIG. 7 is a process flow diagram illustrating an example method, according to some of the above-described techniques, as carried out by a wireless network node supporting carrier aggregation of a primary carrier in Frequency-Division Duplexing (FDD) mode and a secondary carrier in Time-Division Duplexing (TDD) mode. Of course, the illustrated method is applicable to embodiments or instances in which more than one secondary carrier is configured.

As shown at block 710, the illustrated method includes determining that a user device supported or to be supported with said downlink carrier aggregation has delay-sensitive downlink traffic. (The phrase “to be supported” here is meant only to indicate that this step may be carried out with respect to a user device that has not yet, but is about to be, configured for FDD-TDD carrier aggregation.) As shown at block 720, the method further comprises prioritizing subsequent scheduling of the first user device's delay-sensitive downlink traffic in transmission-time intervals (TTIs) in which the subframe of the secondary carrier is an uplink subframe, based on the determination that the user device has delay-sensitive downlink traffic. In some embodiments, this prioritization may be further based on a determination that the user device has additional downlink traffic that requires usage of the secondary cell. In some embodiments, as shown in the detailed examples provided above, the delay-sensitive downlink traffic is voice-over-Internet-Protocol (VoIP) traffic.

In some embodiments or instances of the illustrated method, prioritizing subsequent scheduling of the first user device's delay-sensitive downlink traffic in TTIs in which the subframe of the secondary carrier is an uplink subframe means scheduling all or substantially all of the first user device's delay-sensitive downlink traffic in said TTIs. In some embodiments or instances, where the downlink carrier aggregation includes only a single secondary carrier, prioritizing of subsequent scheduling of the first user device's delay-sensitive downlink traffic in TTIs in which the subframe of the secondary carrier is an uplink subframe may comprise, for each TTI in which the subframe of the secondary carrier is an uplink subframe, scheduling available delay-sensitive downlink traffic for the first user device and/or delay-sensitive downlink traffic for any other user device in the TTI, before scheduling any non-delay sensitive downlink traffic in the TTI.

In some embodiments or instances of the illustrated method, the method further comprises scheduling at least some non-delay-sensitive downlink traffic for the first user device in TTIs in which the subframe of the secondary carrier is not an uplink subframe. This is shown at block 730 of FIG. 7, which is shown with a dashed outline to indicate that it need not be present in every embodiment or instance of the illustrated process. In some of these embodiments, the method still further comprises monitoring hybrid automatic-repeat-request (HARQ) feedback for the first user device and scheduling a sufficient portion of the non-delay-sensitive downlink traffic in TTIs in which the subframe of the secondary carrier is an uplink subframe, to ensure that at least a predetermined proportion of unambiguous HARQ feedback is received for the first user device. This is shown at blocks 740 and 750 of FIG. 7.

It will be appreciated that embodiments of the presently disclosed technology include apparatus configured to carry out the various network-based and terminal-based methods described above. Thus, for example, embodiments include a wireless network node for use in a wireless network node supporting downlink carrier aggregation of a primary carrier in FDD mode and a secondary carrier in TDD mode, where the wireless network node is adapted to: determine that a first user device supported or to be supported with said downlink carrier aggregation has delay-sensitive downlink traffic; and prioritize subsequent scheduling of the first user device's delay-sensitive downlink traffic in TTIs in which the subframe of the secondary carrier is an uplink subframe.

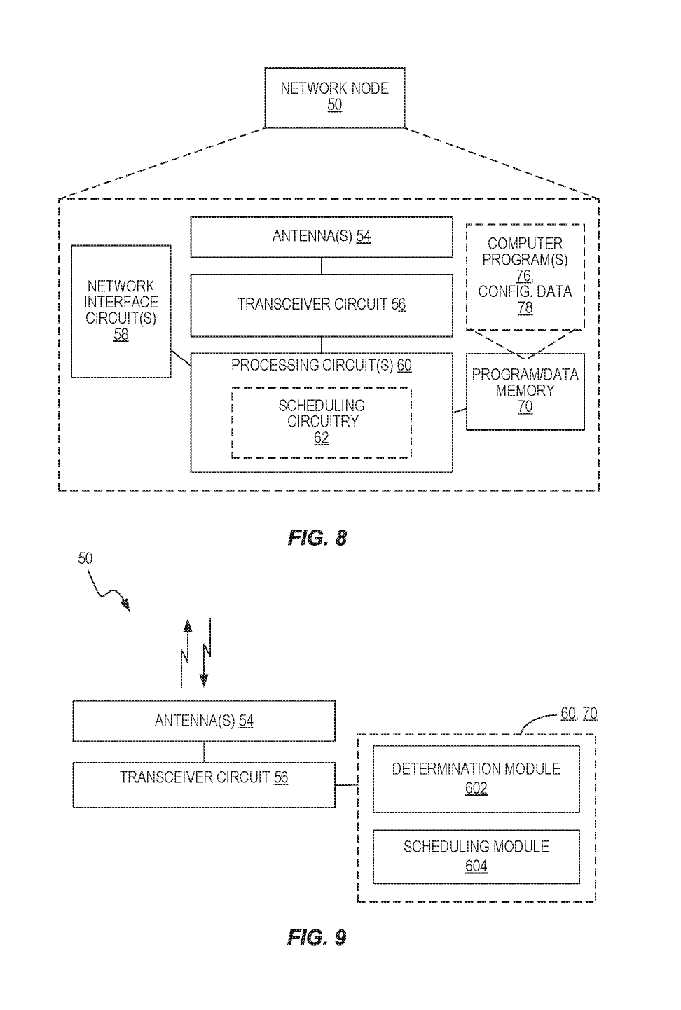

Several of the techniques and methods described above may be implemented using radio circuitry and electronic data processing circuitry provided in a wireless network node supporting downlink carrier aggregation of a primary carrier in FDD mode and a secondary carrier in TDD mode. FIG. 8 illustrates features of an example wireless network node 50 in which a method embodying any of the presently described network-based techniques can be implemented. The network node 50 provides an air interface to user device, e.g., an LTE air interface for downlink transmission and uplink reception, which is implemented via antennas 54 and a transceiver circuit 56. The transceiver circuit 56 may include transmitter circuits, receiver circuits, and associated control circuits that are collectively configured to transmit and receive signals according to a radio access technology, for the purposes of providing cellular communication services. According to various embodiments, cellular communication services may be operated according to any one or more of the 3GPP cellular standards, GSM, GPRS, WCDMA, HSDPA, LTE and LTE-Advanced. The network node 50 may also include network interface circuits 58 for communicating with nodes in the core network, other peer radio nodes, and/or other types of nodes in the network. The network node 50 may be, for example, a base station such as an eNodeB.

The network node 50 also includes one or more processing circuits 60 that are operatively associated with the radio transceiver circuit 56. For ease of discussion, the one or more processing circuits 60 are referred to hereafter as “the processing circuit 60”. The processing circuit 60 comprises one or more digital processing circuits, e.g., one or more microprocessors, microcontrollers, Digital Signal Processors or DSPs, Field Programmable Gate Arrays or FPGAs, Complex Programmable Logic Devices or CPLDs, Application Specific Integrated Circuits or ASICs, or any mix thereof. More generally, the processing circuit 60 may comprise fixed circuitry, or programmable circuitry that is specially adapted via the execution of program instructions implementing the functionality taught herein, or may comprise some mix of fixed and programmed circuitry. The processing circuit 60 may be a multi-core based processing circuit having two or more processor cores utilized for enhanced performance, reduced power consumption, and more efficient simultaneous processing of multiple tasks.

The processing circuit 60 is also associated with memory 70. The memory 70, in some embodiments, stores one or more computer programs 76 and, optionally, configuration data 78. The memory 70 provides non-transitory storage for the computer program 76 and it may comprise one or more types of computer-readable media, such as disk storage, solid-state memory storage, or any mix thereof. By way of non-limiting example, the memory 70 comprises any one or more of SRAM, DRAM, EEPROM, and FLASH memory. In the case of a multi-core processing circuit, a large number of processor cores may share resources, such as memory 70.

In general, the memory 70 comprises one or more types of computer-readable storage media providing non-transitory storage of the computer program and any configuration data used by the network node 50. Here, “non-transitory” means permanent, semi-permanent, or at least temporarily persistent storage and encompasses both long-term storage in non-volatile memory and storage in working memory, e.g., for program execution.

The processing circuit 60, when coupled with an appropriately loaed program data memory 70, is configured to carry out one or more of the techniques described above. Thus, for example, processing circuit 60 is configured, in some embodiments, to determine that a first user device supported or to be supported with said downlink carrier aggregation has delay-sensitive downlink traffic, and to prioritize subsequent scheduling of the first user device's delay-sensitive downlink traffic in TTIs in which the subframe of the secondary carrier is an uplink subframe. The processing circuit 60 may be configured to perform other embodiments as described herein, including any of the methods and variants discussed above in connection with the process flow diagrams of FIGS. 5 and 7.

FIG. 9 schematically illustrates an alternative view of a network node 50 configured to carry out one or more of the methods described above. FIG. 9 illustrates an example functional module or circuit architecture as may be implemented in the network node 50, e.g., based on the processing circuit 60 executing computer program instructions included in the computer program 76 stored in the storage memory 70. The illustrated embodiment at least functionally includes a determination module 602 for determining that a first user device supported or to be supported with said downlink carrier aggregation has delay-sensitive downlink traffic, such as VoIP traffic. The embodiment also includes a scheduling module 604 for prioritizing subsequent scheduling of the first user device's delay-sensitive downlink traffic in TTIs in which the subframe of the secondary carrier is an uplink subframe, based upon the determination that the first user device has delay-sensitive traffic. Scheduling module 604 may be adapted to perform this prioritizing based further on a determination, by determination module 602, that the first user device has has additional downlink traffic that requires usage of the secondary cell.

It will be appreciated that each of the several modules shown in FIG. 9 may be implemented, in full or in part, with appropriate program code running on a processor; thus, the various modules may be understood to correspond to modules or units of program code, in some embodiments, and to corresponding hardware and/or hardware/software combinations, in others, and to a mixture of both, in still others. Further, it will be appreciated that these modules may be configured according to any of the variations of the techniques described above, and in particular may be configured to carry out any of the variations described above in connection with the method illustrated in FIG. 7.

The techniques and apparatus described above will allow VOIP users in joint FDD and TDD carrier aggregation mode, with the primary cell operating in FDD mode, to use their secondary cells to handle additional traffic if required, while maintaining the VOIP system capacity and VOIP user satisfaction. The avoidance of the HARQ ambiguities by using these techniques and apparatus will make PDCCH link adaptation more efficient, as the PDCCH link adaption process implemented by the wireless network node (e.g., the LTE eNB) will get updated more frequently with unambiguous feedback. Consequently the scheduler will perform efficiently by selecting the optimal number of Control Channel Elements (CCEs) for sending downlink assignments, resulting in better PDCCH usage. The capacity can be increased, allowing more VOIP users in the system and increasing the chances that VOIP users to be scheduled when required. The absence of HARQ ambiguity between the DTX and NACK for the VOIP packets will also allow proper retransmission of packets, reducing the unnecessary re-transmission of packets as new transmissions. The PDSCH link adaptation will also get more efficient as it will get more unambiguous feedback. This results in eventual throughput increase and a reduction of latency. The VOIP quality for the users is then preserved.

It will be appreciated by the person of skill in the art that various modifications may be made to the above described embodiments without departing from the scope of the present invention. For example, although embodiments of the present invention have been described with examples that include a communication system compliant to the 3GPP-specified LTE standards, it should be noted that the solutions presented may be equally well applicable to other networks that support dual connectivity. The specific embodiments described above should therefore be considered exemplary rather than limiting the scope of the invention. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

In the present description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions, which can be understood to constitute a “computer program product,” may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) running on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure, and shall not be restricted or limited by the foregoing detailed description.

1. A method, in a wireless network node supporting downlink carrier aggregation of a primary carrier in Frequency-Division Duplexing (FDD) mode and a secondary carrier in Time-Division Duplexing (TDD) mode, the method comprising:
determining that a first user device supported or to be supported with said downlink carrier aggregation has delay-sensitive downlink traffic; and,
based on said determining, prioritizing subsequent scheduling of the first user device's delay-sensitive downlink traffic in transmission-time intervals (TTIs) in which the subframe of the secondary carrier is an uplink subframe.

2. The method of claim 1, wherein the delay-sensitive downlink traffic is voice-over-Internet-Protocol (VOIP) traffic.

3. The method of claim 1, wherein said prioritizing is further based on determining that the first user device has additional downlink traffic that requires usage of the secondary cell.

4. The method of claim 1, wherein prioritizing (720) subsequent scheduling of the first user device's delay-sensitive downlink traffic in TTIs in which the subframe of the secondary carrier is an uplink subframe comprises scheduling all or substantially all of the first user device's delay-sensitive downlink traffic in said TTIs.

5. The method of claim 1, wherein said downlink carrier aggregation comprises only a single secondary carrier, and wherein prioritizing subsequent scheduling of the first user device's delay-sensitive downlink traffic in TTIs in which the subframe of the secondary carrier is an uplink subframe comprises, for each TTI in which the subframe of the secondary carrier is an uplink subframe, scheduling available delay-sensitive downlink traffic for the first user device and/or delay-sensitive downlink traffic for any other user device in the TTI, before scheduling any non-delay sensitive downlink traffic in the TTI.

6. The method of claim 1, further comprising scheduling at least some non-delay-sensitive downlink traffic for the first user device in TTIs in which the subframe of the secondary carrier is not an uplink subframe.

7. The method of claim 6, further comprising monitoring hybrid automatic-repeat-request (HARQ), feedback and scheduling a sufficient portion of the non-delay-sensitive downlink traffic in TTIs in which the subframe of the secondary carrier is an uplink subframe to ensure that at least a predetermined proportion of unambiguous HARQ feedback is received for the first user device.

8. A network node supporting downlink carrier aggregation of a primary carrier in Frequency-Division Duplexing (FDD) mode and a secondary carrier in Time-Division Duplexing (TDD) mode, the network node comprising:
a radio transceiver circuit configured to communicate with one or more user devices; and
a processing circuit configured to control the radio transceiver circuit and to:
determine that a first user device supported or to be supported with said downlink carrier aggregation has delay-sensitive downlink traffic, and prioritize subsequent scheduling of the first user device's delay-sensitive downlink traffic in transmission-time intervals (TTIs) in which the subframe of the secondary carrier is an uplink subframe, based on said determination.

9. The network node of claim 8, wherein the delay-sensitive downlink traffic is voice-over-Internet-Protocol (VoIP) traffic.

10. The network node of claim 8, wherein the processing circuit (850) is configured to perform said prioritizing based further on a determination that the first user device has additional downlink traffic that requires usage of the secondary cell.

11. The network node of claim 8, wherein the processing circuit (850) is configured to prioritize subsequent scheduling of the first user device's delay-sensitive downlink traffic in TTIs in which the subframe of the secondary carrier is an uplink subframe by scheduling all or substantially all of the first user device's delay-sensitive downlink traffic in said TTIs.

12. The network node of claim 8, wherein said downlink carrier aggregation comprises only a single secondary carrier, and wherein the processing circuit is configured to prioritize subsequent scheduling of the first user device's delay-sensitive downlink traffic in TTIs in which the subframe of the secondary carrier is an uplink subframe by, for each TTI in which the subframe of the secondary carrier is an uplink subframe, scheduling available delay-sensitive downlink traffic for the first user device and/or delay-sensitive downlink traffic for any other user device in the TTI, before scheduling any non-delay sensitive downlink traffic in the TTI.

13. The network node of claim 8, wherein the processing circuit is further configured to schedule at least some non-delay-sensitive downlink traffic for the first user device in TTIs in which the subframe of the secondary carrier is not an uplink subframe.

14. The network node of claim 13, wherein the processing circuit is further configured to monitor hybrid automatic-repeat-request (HARQ) feedback and schedule a sufficient portion of the non-delay-sensitive downlink traffic in TTIs in which the subframe of the secondary carrier is an uplink subframe to ensure that at least a predetermined proportion of unambiguous HARQ feedback is received for the first user device.

15. A non-transitory computer-readable medium comprising, stored thereupon, a computer program product comprising program instructions that, when executed by a processor in a wireless network node supporting downlink carrier aggregation of a primary carrier in Frequency-Division Duplexing (FDD) mode and a secondary carrier in Time-Division Duplexing (TDD) mode, cause the wireless network node to:
determine that a first user device supported or to be supported with said downlink carrier aggregation has delay-sensitive downlink traffic, and
prioritize subsequent scheduling of the first user device's delay-sensitive downlink traffic in transmission-time intervals, TTIs, in which the subframe of the secondary carrier is an uplink subframe.

16. (canceled)

17. (canceled)

18. The network node of claim 15, wherein the network node is adapted to perform said prioritizing based further on a determination that the first user device has additional downlink traffic that requires usage of the secondary cell.

19. The network node of claim 15, wherein the network node is adapted to prioritize subsequent scheduling of the first user device's delay-sensitive downlink traffic in TTIs in which the subframe of the secondary carrier is an uplink subframe by scheduling all or substantially all of the first user device's delay-sensitive downlink traffic in said TTIs.

20. The network node of claim 15, wherein said downlink carrier aggregation comprises only a single secondary carrier, and wherein the network node is adapted to prioritize subsequent scheduling of the first user device's delay-sensitive downlink traffic in TTIs in which the subframe of the secondary carrier is an uplink subframe by, for each TTI in which the subframe of the secondary carrier is an uplink subframe, scheduling available delay-sensitive downlink traffic for the first user device and/or delay-sensitive downlink traffic for any other user device in the TTI, before scheduling any non-delay sensitive downlink traffic in the TTI.

21. The network node of claim 15, wherein the network node is further adapted to schedule at least some non-delay-sensitive downlink traffic for the first user device in TTIs in which the subframe of the secondary carrier is not an uplink subframe.

22. The network node of claim 21, wherein the network node is further adapted to monitor hybrid automatic-repeat-request (HARQ) feedback and schedule a sufficient portion of the non-delay-sensitive downlink traffic in TTIs in which the subframe of the secondary carrier is an uplink subframe to ensure that at least a predetermined proportion of unambiguous HARQ feedback is received for the first user device.

23. (canceled)

24. (canceled)

25. (canceled)

26. (canceled)

27. (canceled)

28. (canceled)

29. (canceled).
